(19) United States
(12) Patent Application Publication
(10) Pub. No.: US 2026/0179596 A1
(43) Pub. Date: Jun. 25, 2026

(54) KEYBOARD DEVICE, ELECTRONIC PIANO AND HAMMER SUPPORT METHOD

(71) Applicant: Roland Corporation, Shizuoka (JP)

(72) Inventor: Yukihide Takata, Shizuoka (JP)

(73) Assignee: Roland Corporation, Shizuoka (JP)

(21) Appl. No.: 19/393,576

(22) Filed: Nov. 19, 2025

(30) Foreign Application Priority Data
Dec. 23, 2024 (JP) 2024-226227

(51) Int. Cl. G10H 1/34

(52) U.S. Cl. CPC G10H 1/346; G10H 2220/221; G10H 2220/275

(57) ABSTRACT

A keyboard device according to the disclosure includes: a key which has a back end side swingably supported; a hammer with which the key is rotatably engaged and which rotates in conjunction with swinging of the key; and a support member which has a support surface that slidably supports an outer peripheral surface of a rotation shaft of the hammer, in which the support surface inclines with respect to a horizontal direction, and the rotation shaft of the hammer ascends or descends on the support surface during swinging of the key.

### CROSS-REFERENCE TO RELATED APPLICATION

This application claims the priority benefit of Japanese application serial no. 2024-226227, filed on Dec. 23, 2024. The entirety of the above-mentioned patent application is hereby incorporated by reference herein and made a part of this specification.

### TECHNICAL FIELD

The disclosure relates to a keyboard device and a hammer support method, and particularly relates to a keyboard device and a hammer support method that can provide a favorable key pressing feel while reducing product cost.

### BACKGROUND ART

For example, Patent Document 1 describes a technology that applies an elastic force of an elastic body 8 to a hammer 6 to provide a reaction load Fa that the player feels as a reaction force during key pressing and an auxiliary load Fc that assists a key pressing operation. According to this technology, for example, the reaction load Fa can be gradually reduced from the initial position of key pressing to make the feel sensed during key pressing lighter compared to the feel near the initial position of key pressing. Therefore, compared to the case where the key pressing feel is provided only with the mass of the hammer 6, the player can have a favorable key pressing feel.
[Patent Document 1] Japanese Patent Application Laid-Open No. 2022-070658 (for example, paragraphs 0030 to 0035 and FIG. 3)

In the technology described above, however, the elastic body 8 used is a separate component from the hammer 6, and for this reason, the number of components increases. Therefore, there is a problem that the product cost of the keyboard device increases.

The disclosure provides a keyboard device and a hammer support method that can provide a favorable key pressing feel while reducing product cost.

### SUMMARY

A keyboard device according to the disclosure includes: a key which has a back end side swingably supported; a hammer with which the key is rotatably engaged and which rotates in conjunction with swinging of the key; and a support member which has a support surface that slidably supports an outer peripheral surface of a rotation shaft of the hammer, in which the support surface inclines with respect to a horizontal direction, and the rotation shaft of the hammer ascends or descends on the support surface during swinging of the key.

A hammer support method according to the disclosure is provided for a keyboard device that includes a key which has a back end side swingably supported, a hammer with which the key is rotatably engaged and which rotates in conjunction with swinging of the key, and a support member which has a support surface that supports a rotation shaft of the hammer. The hammer support method includes: slidably supporting an outer peripheral surface of the rotation shaft of the hammer on the support surface that inclines with respect to a horizontal direction; and causing the rotation shaft of the hammer to ascend or descend on the support surface during swinging of the key.

### BRIEF DESCRIPTION OF THE DRAWINGS

FIG. 1 is an exploded perspective view of the keyboard device 1 in the first embodiment.

FIG. 2 is a cross-sectional view of the keyboard device.

FIG. 3A is a partially enlarged cross-sectional view of the keyboard device showing an enlarged view of the portion IIIa in FIG. 2, and FIG. 3B is a partially enlarged cross-sectional view of the keyboard device showing a state where the key has rotated from the state of FIG. 3A to an intermediate position of key pressing.

FIG. 4A is a partially enlarged cross-sectional view of the keyboard device showing a state where the key has rotated from the state of FIG. 3B to the terminal position of key pressing, and FIG. 4B is a graph showing the relationship between the stroke amount of the key and the load acting on the key from the hammer.

FIG. 5A is a partially enlarged cross-sectional view of the keyboard device of the second embodiment, and FIG. 5B is a graph showing the relationship between the stroke amount of the key and the load acting on the key from the hammer.

FIG. 6A is a partially enlarged cross-sectional view of the keyboard device of the third embodiment, and FIG. 6B is a graph showing the relationship between the stroke amount of the key and the load acting on the key from the hammer.

FIG. 7 is an exploded perspective view of the keyboard device of the fourth embodiment.

### DESCRIPTION OF THE EMBODIMENTS

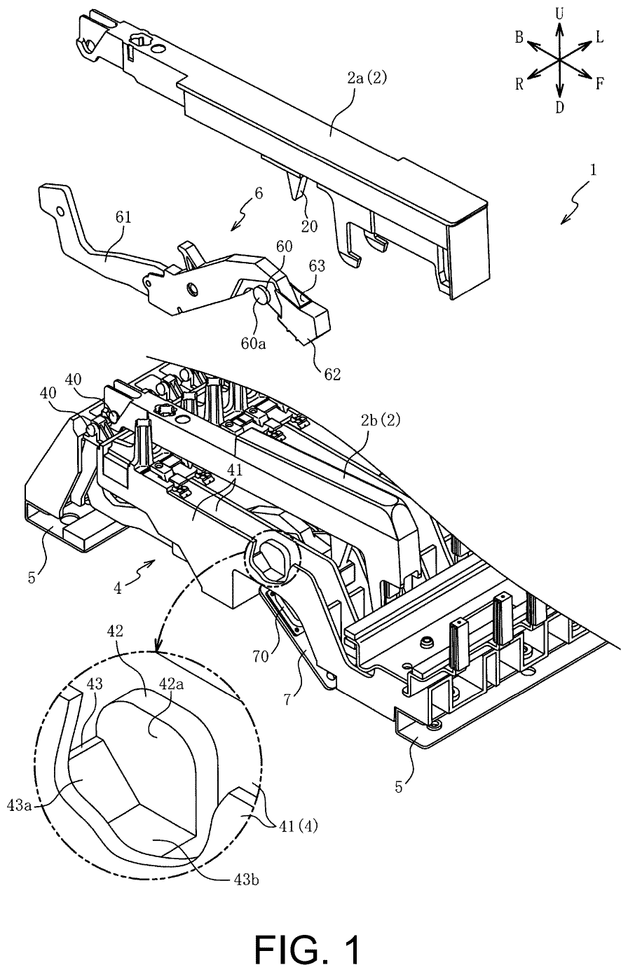

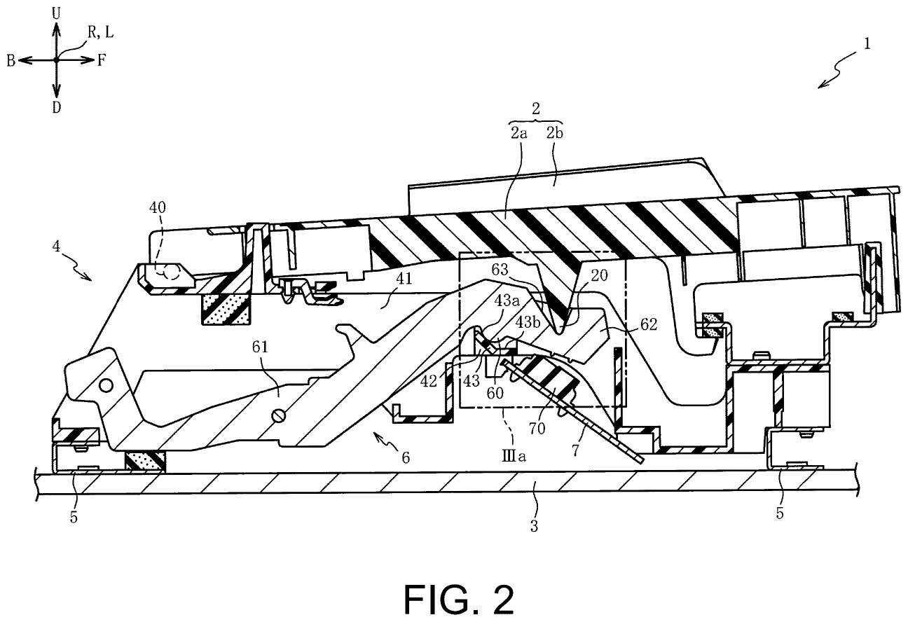

Hereinafter, exemplary embodiments will be described with reference to the accompanying drawings. First, the overall configuration of a keyboard device 1 will be described with reference to FIG. 1 and FIG. 2. FIG. 1 is an exploded perspective view of the keyboard device 1 in the first embodiment, and FIG. 2 is a cross-sectional view of the keyboard device 1. FIG. 1 illustrates a state where a part of a partition wall 41 of a chassis 4 is broken by a break line to expose a support surface 43a (see the enlarged portion in FIG. 1) that supports a rotation shaft 60 of a hammer 6.

Further, the directions of arrows U-D, F-B, and L-R in FIG. 1 respectively indicate an up-down direction, a front-back direction, and a left-right direction (an arrangement direction of multiple keys 2, hereinafter referred to as “scale direction”) of the keyboard device 1, and the same applies to FIG. 2 and subsequent drawings. FIG. 2 is a cross-sectional view of the keyboard device 1 cut along a plane orthogonal to the scale direction.

As shown in FIG. 1, the keyboard device 1 is a device that constitutes a keyboard instrument (an electronic piano or synthesizer), and includes multiple (88 in the present embodiment) keys 2 to be pressed by the player. The keys 2 include multiple (52 in the present embodiment) white keys 2a for playing natural tones and multiple (36 in the present embodiment) black keys 2b for playing derived sounds, and the multiple white keys 2a and black keys 2b are arranged in the scale direction (direction of arrow L-R).

The keyboard device 1 includes a shelf board 3 (see FIG. 2) for supporting the keys 2, and the shelf board 3 is formed in a flat plate shape extending in the scale direction using synthetic resin, steel plate, or the like. A chassis 4 made of resin is supported on the upper surface of the shelf board 3. The chassis 4 has both front and back end portions (direction of arrow F-B) fixed to the shelf board 3 via channel members 5, and a shaft-shaped rotation shaft 40 extending along the scale direction is provided on the upper surface of the back end side (side of arrow B) of the chassis 4. The back end portion of the key 2 is rotatably (swingably) supported by the rotation shaft 40.

The chassis 4 is formed with flat plate-shaped partition walls 41 extending in the front-back direction, and hammers 6 that interlock with rotation of the keys 2 are accommodated between the opposing partition walls 41 arranged in the scale direction. Guide portions 42 (see the enlarged portion in FIG. 1) that protrude opposing each other are formed on the respective side surfaces of the multiple partition walls 41. Although not illustrated, the guide portions 42 are formed as a pair so as to oppose each other in the scale direction, and this pair of guide portions 42 are connected by a support portion 43 (see the enlarged portion in FIG. 1). These guide portions 42 and support portion 43 are formed integrally with the partition walls 41 (chassis 4), but these may be formed as separate bodies.

On the upper surface of the support portion 43, a support surface 43a that has a descending inclination toward the front side (side of arrow F), and a horizontal surface 43b that connects to the front end of the support surface 43a and extends in the front-back direction (horizontally) are formed. The support surface 43a is a flat surface that inclines at a constant gradient from the back end side to the front end side, and a rotation shaft 60 formed integrally with the hammer 6 is supported on the support surface 43a. This horizontal surface 43b is configured as a tray to prevent grease applied to the support surface 43a (i.e., inclined surface) from dripping down.

The rotation shaft 60 is formed in a columnar shape with an axis oriented in the scale direction, and although details will be described later, the rotation shaft 60 rotates while sliding on the support surface 43a during rotation of the hammer 6 that accompanies pressing of the key 2. The slide displacement of the rotation shaft 60 on this support surface 43a is guided by the guide portion 42.

The side surfaces of the guide portion 42 are configured as guide surfaces 42a (see the enlarged portion in FIG. 1) that guide sliding of the rotation shaft 60, and the side surfaces on both end sides in the scale direction of the rotation shaft 60 are respectively configured as guided surfaces 60a (see FIG. 1). These guide surfaces 42a and guided surfaces 60a are respectively planes orthogonal to the scale direction.

An interval between the pair of guide surfaces 42a facing each other in the scale direction is formed to be substantially the same as (slightly larger than) the thickness of the rotation shaft 60 in the scale direction. Therefore, although not illustrated, in a state where the rotation shaft 60 is inserted between the pair of opposing guide portions 42, there is a slight gap between the guide surfaces 42a and the guided surfaces 60a, and rotation and sliding of the rotation shaft 60 on the support surface 43a are guided by contact between the guide surfaces 42a and the guided surfaces 60a.

The hammer 6 includes a mass portion 61 (mass body) positioned on the back side (side of arrow B) with respect to the rotation shaft 60, and a pressing portion 62 positioned on the front side (side of arrow F) with respect to the rotation shaft 60. A receiving portion 63 that is recessed downward is formed on the upper surface of the pressing portion 62, and a protrusion portion 20 that protrudes downward from the lower surface of the key 2 is inserted into the receiving portion 63.

The bottom surface of the receiving portion 63 and the lower surface of the protrusion portion 20 are respectively formed in arc shapes, and during rotation of the key 2 that accompanies key pressing, the lower surface of the protrusion portion 20 rotates along the bottom surface of the receiving portion 63. That is, the protrusion portion 20 of the key 2 is pivotally supported by the receiving portion 63 of the hammer 6 so as not to slide.

A substrate 7 having a switch 70 (sensor) on the upper surface is provided below the pressing portion 62, and during pressing of the key 2, the switch 70 is pushed by the pressing portion 62 that displaces downward. Key pressing information (note information) of the key 2 is detected by on/off of this switch 70, and a musical tone signal based on the detection result is output to the outside.

In addition, during pressing of the key 2, the hammer 6 rotates around the rotation shaft 60, and the mass portion 61 is lifted by this rotation of the hammer 6. The reaction force accompanying this rotation of the hammer 6 provides the player a key pressing feel during pressing of the key 2.

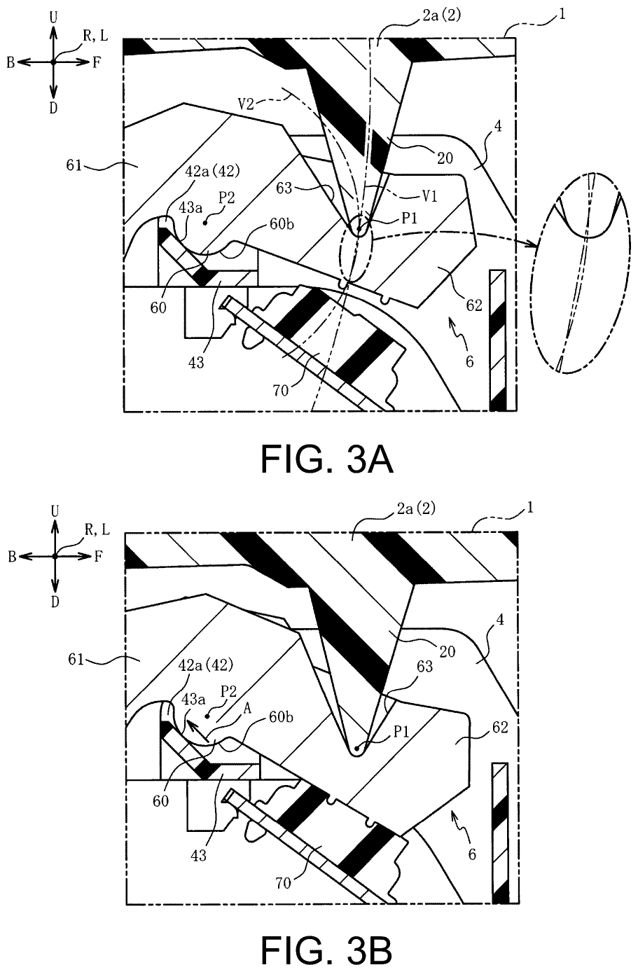

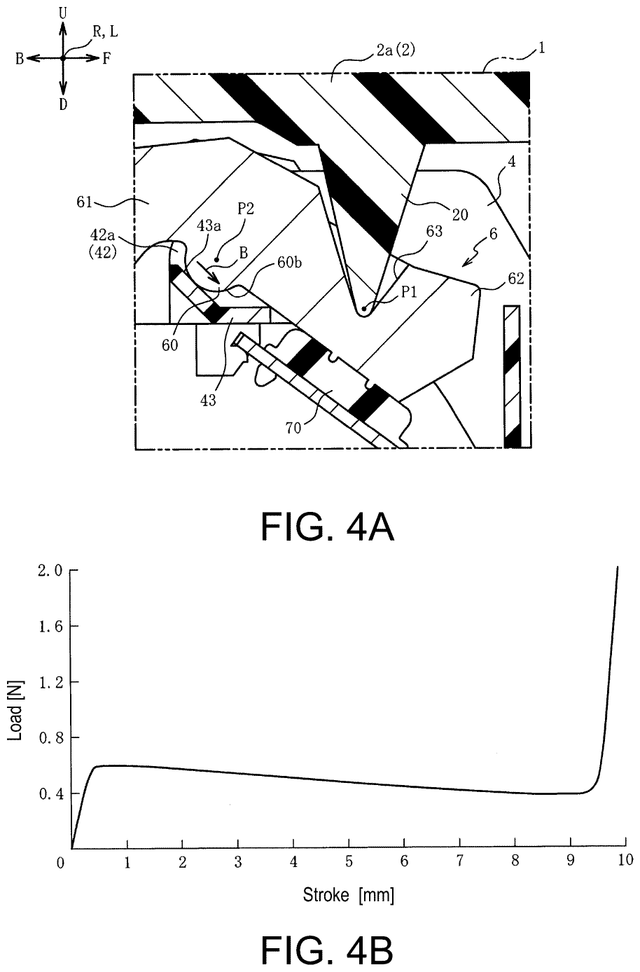

Next, the detailed configuration of the keyboard device 1 will be described with reference to FIG. 3A, FIG. 3B, FIG. 4A, and FIG. 4B. FIG. 3A is a partially enlarged cross-sectional view of the keyboard device 1 showing an enlarged view of the portion IIIa in FIG. 2, and FIG. 3B is a partially enlarged cross-sectional view of the keyboard device 1 showing a state where the key 2 has rotated from the state of FIG. 3A to an intermediate position of key pressing. FIG. 4A is a partially enlarged cross-sectional view of the keyboard device 1 showing a state where the key 2 has rotated from the state of FIG. 3B to the terminal position of key pressing, and FIG. 4B is a graph showing the relationship between the stroke amount of the key 2 and the load acting on the key 2 from the hammer 6.

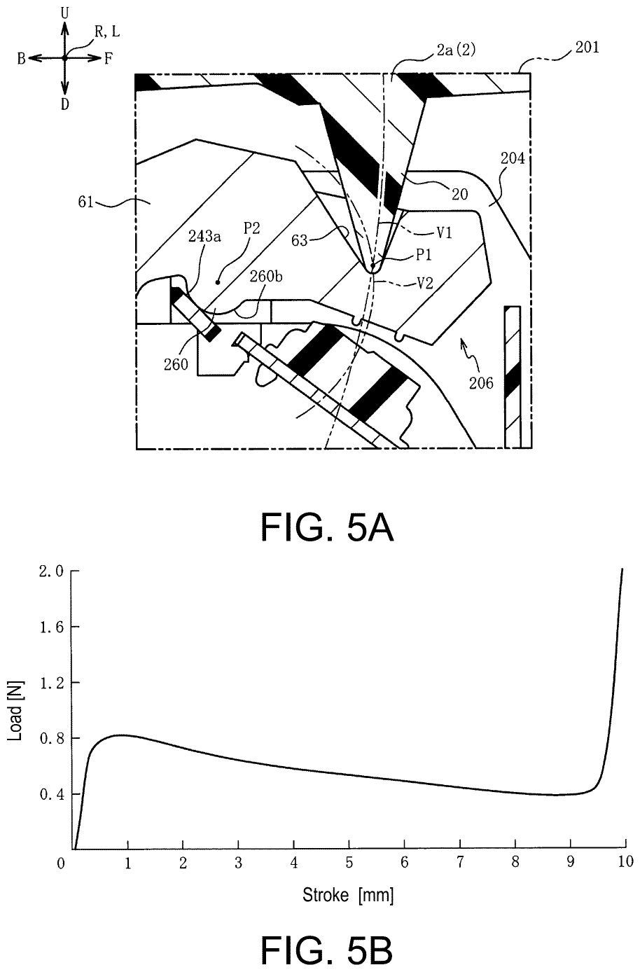

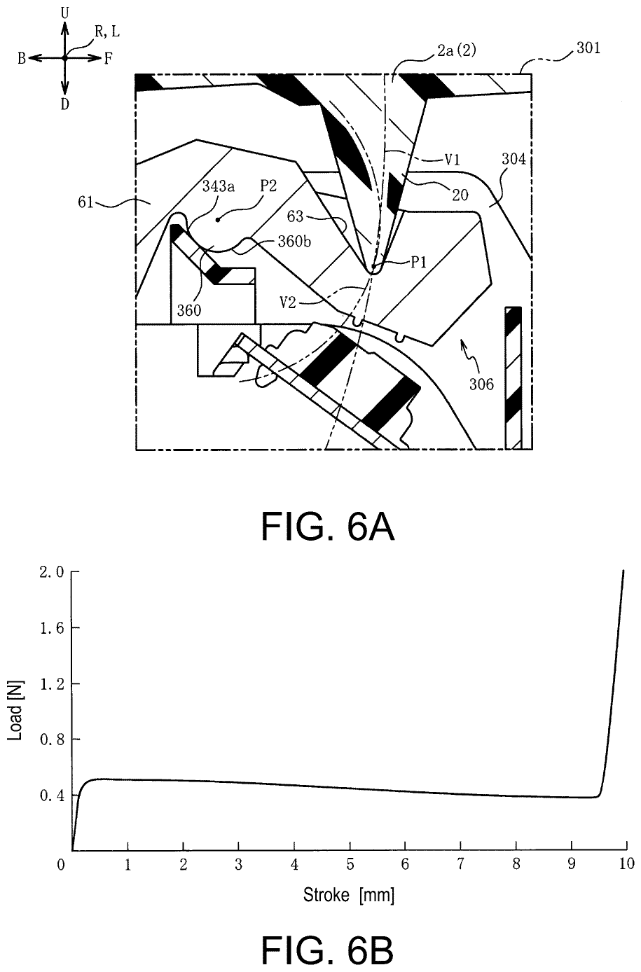

The terminal position of key pressing is a position where the pressing portion 62 of the hammer 6 completely pushes the switch 70 of the substrate 7. Additionally, the vertical axis of the graph in FIG. 4B indicates the magnitude of load (N), and the horizontal axis indicates the stroke amount of the key 2 (the same applies to FIG. 5B and FIG. 6B which will be described later).

As shown in FIG. 3A and FIG. 3B, during rotation of the key 2 (in the example shown in FIG. 3A and FIG. 3B, the white key 2a) that accompanies key pressing, the protrusion portion 20 rotates around the center of a circle including the lower surface of the arc-shaped protrusion portion 20 (the bottom surface of the receiving portion 63). Hereinafter, the center of this circle (the axial center at the shaft support portion between the key 2 and the hammer 6) will be described as an engagement point P1 between the key 2 and the hammer 6. This engagement point P1 rotates around the rotation shaft 40 (see FIG. 2) along with rotation of the key 2 during key pressing, and in FIG. 3A, the displacement trajectory of the engagement point P1 around the rotation shaft 40 is indicated by a virtual line V1 (hereinafter referred to as “rotation trajectory V1 of the engagement point P1”).

An outer peripheral surface 60b of the rotation shaft 60 formed on the lower surface of the hammer 6 is formed in an arc shape that is convex downward, and at the initial position before the key 2 is pressed, the outer peripheral surface 60b of the rotation shaft 60 is supported by the support surface 43a of the support portion 43 (chassis 4). Hereinafter, a point where the axial center of the rotation shaft 60 (the center of the arc-shaped outer peripheral surface 60b) is positioned at the initial position before key pressing will be described as an initial point P2.

At the initial position before key pressing, the initial point P2 is positioned backward and downward with respect to the engagement point P1, and FIG. 3A shows a virtual circle centered on the initial point P2 and passing through the engagement point P1 at the initial position before key pressing as a virtual circle V2. This virtual circle V2 can also be said to be a circle connecting points equidistant from the initial point P2.

The rotation trajectory V1 of the engagement point P1 between the key 2 and the hammer 6 has an arc shape with a smaller curvature (larger radius of curvature) than the virtual circle V2, and in the present embodiment, the rotation trajectory V1 of the engagement point P1 intersects with the virtual circle V2 (see the enlarged portion in FIG. 3A). That is, in the case where the key 2 rotates from the initial position before key pressing (the state in FIG. 3A) to the intermediate position of key pressing (the state in FIG. 3B), the engagement point P1 approaches the initial point P2, while in the case where the key 2 rotates from the intermediate position to the terminal position of key pressing, the engagement point P1 moves away from the initial point P2.

Therefore, in the case where the key 2 rotates from the initial position before key pressing shown in FIG. 3A to the intermediate position of key pressing shown in FIG. 3B, the hammer 6 is pushed backward (side of arrow B) by the protrusion portion 20 of the key 2. Due to this pushing, the rotation shaft 60 of the hammer 6 slides while rotating so as to ascend the support surface 43a (see arrow A in FIG. 3B).

Further, in the case where the key 2 is further pressed from the state shown in FIG. 3B and rotates to the terminal position shown in FIG. 4A, the hammer 6 is pulled back frontward (side of arrow F) by the protrusion portion 20 of the key 2, whereby the rotation shaft 60 of the hammer 6 slides while rotating so as to descend the support surface 43a (see arrow B in FIG. 4A). In other words, the rotation shaft 60 of the hammer 6 reciprocates (ascends and descends) on the support surface 43a from the initial position to the terminal position of key pressing.

Thus, in the present embodiment, the support surface 43a that slidably supports the rotation shaft 60 of the hammer 6 inclines with respect to the horizontal direction, and is configured to cause the rotation shaft 60 to ascend and descend on the support surface 43a during pressing of the key 2, thereby obtaining a result that the load acting on the key 2 from the hammer 6 (the load that the player senses as a reaction force) gradually decreases from the initial position to the terminal position of key pressing, as shown in FIG. 4B. This can gradually lighten the key pressing feel as it approaches the terminal position of key pressing without using elastic bodies or magnets as in the related technology. Therefore, while the number of components of the keyboard device 1 is reduced to reduce product cost, the player can have a favorable playing feel.

Further, by adjusting the relative position between the rotation shaft 40 of the key 2 (see FIG. 2) and the engagement point P1 (the curvature of the rotation trajectory V1 shown in FIG. 3A), or by adjusting the relative position between the engagement point P1 and the initial point P2 (support surface 43a) (the curvature of the virtual circle V2), it is possible to change the load acting on the key 2 from the hammer 6 from the initial position to the terminal position of key pressing (for example, the slope of the graph shown in FIG. 4B). In addition, by adjusting the inclination angle of the support surface 43a with respect to the horizontal direction, the position of the center of gravity of the hammer 6, or the like, it is possible to change the load acting on the key 2. Thus, by adjusting the positional relationship of each part of the keyboard device 1, the player can have a favorable playing feel.

Furthermore, in the present embodiment, the switch 70 is pushed by the pressing portion 62 of the hammer 6 during pressing of the key 2, but the load acting on the key 2 from the hammer 6 gradually decreases while this switch 70 is being pushed. That is, since the key pressing feel near the terminal position (in the case where the switch 70 is being pushed) becomes relatively light compared to the feel near the initial position of key pressing, it is possible to make it difficult for the player to sense the reaction force in the case of the switch 70 being pushed. This also enables the player to have a favorable playing feel.

Thus, it is presumed that the inclination direction of the support surface 43a is important in addition to the positional relationship of each part of the keyboard device 1 described above, in order to gradually reduce the change in load acting on the key 2 from the hammer 6 toward the terminal position. That is, the support surface 43a of the first embodiment has a descending inclination toward the engagement point P1 side (side of arrow F) between the key 2 and the hammer 6, but for example, in a configuration where the support surface 43a has a descending inclination in the direction away from the engagement point P1 (side of arrow B), the result is that the load acting on the key 2 from the hammer 6 becomes difficult to decrease from the initial position to the terminal position.

Therefore, it is preferable that the support surface 43a has a descending inclination toward the engagement point P1 side between the key 2 and the hammer 6. This makes it easy for the load acting on the key 2 from the hammer 6 to decrease from the initial position to the terminal position, so that the player can have a favorable key pressing feel.

Here, by adjusting the positional relationship of each part of the keyboard device 1, it is also possible to adopt a configuration in which the rotation shaft 260 of the hammer 206 continues to ascend on the support surface 243a from the initial position before key pressing to the terminal position, or a configuration in which the rotation shaft 360 of the hammer 306 continues to descend on the support surface 343a, as in the second and third embodiments (see FIG. 5A, FIG. 5B, FIG. 6A, and FIG. 6B) described later. However, for the configurations of the second and third embodiments, it is required to form the slide regions of the hammers 206 and 306 (rotation shafts 260 and 360) on the support surfaces 243a and 343a long in the front-back direction.

In contrast thereto, in the present embodiment, the rotation shaft 60 of the hammer 6 descends after ascending on the support surface 43a from the initial position before key pressing to the terminal position. That is, since the rotation shaft 60 reciprocates on the support surface 43a, the length of the support surface 43a in the front-back direction (the slide region of the rotation shaft 60) can be formed shorter compared to a configuration in which the rotation shaft 60 continues to ascend or descend on the support surface 43a from the initial position before key pressing to the terminal position as described above. By forming the support surface 43a short, constraints on the arrangement space of other members are less likely to occur, so that the flexibility in designing the keyboard device 1 can be improved.

Additionally, the guided surfaces 60a (see FIG. 1) are formed on both sides in the scale direction of the rotation shaft 60 of the hammer 6, and as described above, this pair of guided surfaces 60a are sandwiched by the guide surfaces 42a (see the enlarged portion in FIG. 1) of the guide portion 42. This enables contact between the guide surfaces 42a and the guided surfaces 60a to stably guide the ascending/descending operation of the rotation shaft 60 on the support surface 43a, so that the player can have a favorable key pressing feel.

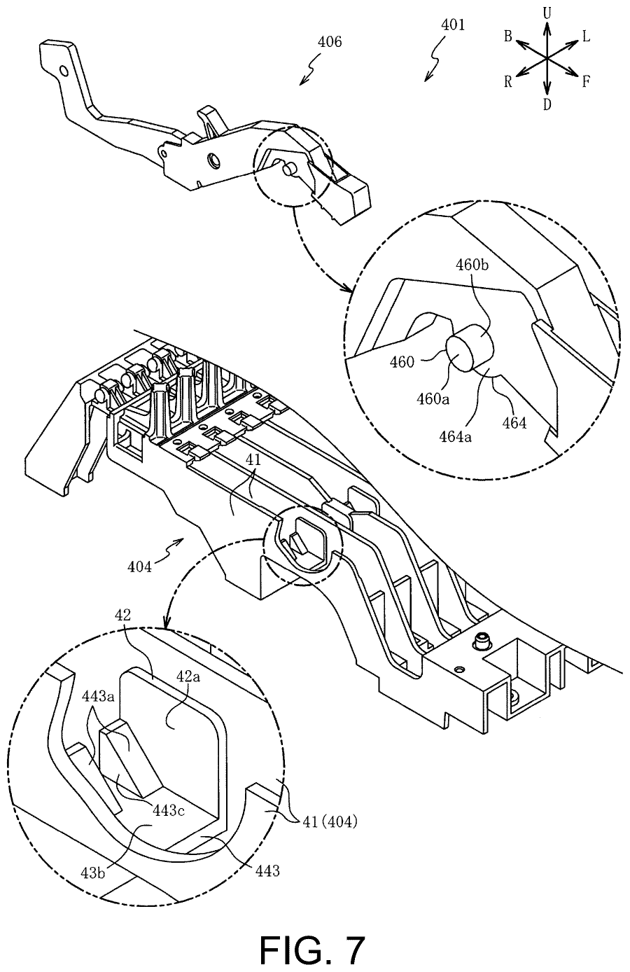

Here, in the present embodiment, one rotation shaft 60 is integrally formed on the lower surface of the hammer 6, but for example, as in the fourth embodiment (see FIG. 7) described later, it is also possible to cause rotation shafts 460 protruding from the hammer 406 to both sides in the scale direction to ascend and descend on a pair of support surfaces 443a. However, for a configuration in which the rotation shafts 460 are formed on both sides in the scale direction of the hammer 406, errors are likely to occur in the shape (curvature) and formation position of the outer peripheral surface 460b between one rotation shaft 460 and the other rotation shaft 460. In the case of such errors occurring, rattling is likely to occur in the rotation and slide operation of the rotation shafts 460 on the support surfaces 443a.

In contrast thereto, with a configuration in which the outer peripheral surface 60b of a single rotation shaft 60 formed on the lower surface of the hammer 6 slides on the support surface 43a as in the present embodiment, the above-mentioned shape errors or the like are less likely to occur. This can stabilize the rotation and slide operation of the rotation shaft 60 on the support surface 43a, so that the player can have a favorable key pressing feel.

Next, keyboard devices 201 and 301 of the second and third embodiments will be described with reference to FIG. 5A, FIG. 5B, FIG. 6A, and FIG. 6B. The same reference numerals are assigned to the same parts as in the first embodiment described above, and description thereof is omitted.

FIG. 5A is a partially enlarged cross-sectional view of the keyboard device 201 of the second embodiment, and FIG. 5B is a graph showing the relationship between the stroke amount of the key 2 and the load acting on the key 2 from the hammer 206 in the second embodiment. FIG. 6A is a partially enlarged cross-sectional view of the keyboard device 301 of the third embodiment, and FIG. 6B is a graph showing the relationship between the stroke amount of the key 2 and the load acting on the key 2 from the hammer 306 in the third embodiment.

As shown in FIG. 5A, in the keyboard device 201 of the second embodiment, the protrusion portion 20 of the key 2 (white key 2a) and the receiving portion 63 of the hammer 206 engage at the engagement point P1 at the same height as the first embodiment described above. On the other hand, the formation position of the support surface 243a of the chassis 204 and the rotation shaft 260 of the hammer 206 (the initial point P2 of the rotation shaft 260) are lower compared to the first embodiment.

That is to say, the rotation trajectory V1 of the engagement point P1 intersects more deeply with the virtual circle V2 compared to the first embodiment, and is configured such that only displacement in which the engagement point P1 approaches the initial point P2 occurs from the initial position before key pressing to the terminal position (the engagement point P1 continues to approach the initial point P2). In the case of the configuration of the second embodiment, although not illustrated, slide displacement occurs in which the rotation shaft 260 of the hammer 206 continues to ascend on the support surface 243a from the initial position to the terminal position of pressing of the key 2 (the rotation shaft 260 descends on the support surface 243a in the case of the key 2 being released).

Thus, in the present embodiment, the support surface 243a that slidably supports the rotation shaft 260 of the hammer 206 also inclines with respect to the horizontal direction, and is configured such that the rotation shaft 260 ascends on the support surface 243a during pressing of the key 2. This configuration also obtains a result that the load acting on the key 2 from the hammer 206 gradually decreases from the initial position to the terminal position of key pressing, as shown in FIG. 5B. This can gradually lighten the key pressing feel as it approaches the terminal position of key pressing without using elastic bodies or magnets as in the related technology.

As shown in FIG. 6A, in the keyboard device 301 of the third embodiment, the protrusion portion 20 of the key 2 (white key 2a) and the receiving portion 63 of the hammer 306 engage at the engagement point P1 at the same height as the first embodiment described above. On the other hand, the formation position of the support surface 343a of the chassis 304 and the rotation shaft 360 of the hammer 306 (the initial point P2 of the rotation shaft 360) is formed higher compared to the first embodiment.

Then, it is configured such that only displacement in which the engagement point P1 moves away from the initial point P2 occurs from the initial position before key pressing to the terminal position (the engagement point P1 continues to move away from the initial point P2). In the case of the configuration of the third embodiment, although not illustrated, slide displacement occurs in which the rotation shaft 360 of the hammer 306 continues to descend on the support surface 343a from the initial position to the terminal position of pressing of the key 2 (the rotation shaft 360 ascends on the support surface 343a in the case of the key 2 being released).

Thus, in the present embodiment, the support surface 343a that slidably supports the rotation shaft 360 of the hammer 306 also inclines with respect to the horizontal direction, and is configured such that the rotation shaft 360 descends on the support surface 343a during pressing of the key 2. This configuration also obtains a result that the load acting on the key 2 from the hammer 306 gradually decreases from the initial position to the terminal position of key pressing, as shown in FIG. 6B. This can gradually lighten the key pressing feel as it approaches the terminal position of key pressing without using elastic bodies or magnets as in the related technology.

By changing the positional relationship of each part of the keyboard devices 201 and 301 as in the second and third embodiments, the load acting on the key 2 from the hammers 206 and 306 from the initial position to the terminal position can be adjusted. Therefore, the player can have a favorable playing feel.

Next, the keyboard device 401 of the fourth embodiment will be described with reference to FIG. 7. The same reference numerals are assigned to the same parts as in each embodiment described above, and description thereof is omitted. FIG. 7 is an exploded perspective view of the keyboard device 401 of the fourth embodiment. FIG. 7 illustrates a state where a part of the partition wall 41 of the chassis 4 is broken by a break line to expose the support surface 443a (see the enlarged portion at the lower left of FIG. 7) that supports the rotation shaft 460 (see the enlarged portion at the upper right of FIG. 7) of the hammer 406.

As shown in FIG. 7, in the keyboard device 401 of the fourth embodiment, a pair of guide portions 42 (see the enlarged portion at the lower left of FIG. 7) facing each other in the scale direction are also connected by a support portion 443, similar to the first embodiment described above. On the upper surface of the support portion 443, support surfaces 443a that have a descending inclination toward the front side (side of arrow F), and a horizontal surface 43b connected to the front ends of the support surfaces 443a are formed. The support surfaces 443a are formed as a pair with an interval in the scale direction. This horizontal surface 43b is configured as a tray to prevent grease applied to the support surfaces 443a (i.e., inclined surfaces) from dripping down.

A guided portion 464 (see the enlarged portion at the upper right of FIG. 7) having the same shape as the rotation shaft 60 (see FIG. 2) described above is integrally formed on the lower surface of the hammer 406, and the side surfaces on both sides in the scale direction of this guided portion 464 are configured as guided surfaces 464a.

Columnar rotation shafts 460 with axes oriented in the scale direction are integrally formed on the guided surfaces 464a (side surfaces of the hammer 406), and although not illustrated, the rotation shafts 460 are respectively provided on the guided surfaces 464a formed on both sides in the scale direction of the hammer 406. That is, the rotation shafts 460 protrude as a pair from the hammer 406 to both sides in the scale direction, and the outer peripheral surfaces 460b of this pair of rotation shafts 460 are supported by the support surfaces 443a.

Guide surfaces 443c (see the enlarged portion at the lower left of FIG. 7) are vertically connected to the inner end portions in the scale direction of the pair of support surfaces 443a, and the guide surfaces 443c are flat surfaces orthogonal to the scale direction. Although not illustrated, in a state where the rotation shafts 460 are supported by the support surfaces 443a, the guided portion 464 of the hammer 406 is inserted between the pair of guide surfaces 443c facing each other in the scale direction. In this inserted state, there is a slight gap between the guide surface 443c and the guided surface 464a of the guided portion 464.

Although not illustrated, in the present embodiment, the hammer 406 (rotation shaft 460) is also configured to ascend and descend on the support surface 443a from the initial position before key pressing to the terminal position. Similar to the first embodiment, this can gradually reduce the load acting on the key (not shown) from the hammer 406 from the initial position to the terminal position. Therefore, the key pressing feel can be gradually lightened as it approaches from the initial position of key pressing to the terminal position without using elastic bodies or magnets as in the related technology. Accordingly, while the number of components of the keyboard device 1 is reduced to reduce product cost, the player can have a favorable playing feel.

Further, since the guided surfaces 464a provided on both sides in the scale direction of the guided portion 464 are sandwiched between the pair of guide surfaces 443c, the ascending/descending operation of the rotation shafts 460 on the support surfaces 443a can be stably guided by contact between the guide surfaces 443c and the guided surfaces 464a. Therefore, the player can have a favorable key pressing feel.

In the present embodiment, the sliding of the rotation shaft 460 is guided by contact between the guide surface 443c and the guided surface 464a, but the disclosure is not necessarily limited thereto. For example, the sliding of the rotation shaft 460 may be guided by bringing the outer side surface 460a in the scale direction of the rotation shaft 460 (see the enlarged portion at the upper right of FIG. 7) into contact with the guide surface 42a of the guide portion 42 (see the enlarged portion at the lower left of FIG. 7).

Although the disclosure has been described based on the above embodiments, the disclosure is not limited to the above embodiments in any way, and it can be easily inferred that various improvements and modifications are possible within the scope that does not depart from the spirit of the disclosure.

Although description is omitted in each of the above embodiments, the angle of the support surfaces 43a, 243a, 343a, and 443a with respect to the horizontal direction is preferably 30° or more and 60° or less, and more preferably 40° or more and 50° or less. By setting the angle within such a range, the player can have a favorable key pressing feel.

Each of the above embodiments illustrates a case where the initial point P2 of the rotation shafts 60, 260, and 360 is positioned on the back side with respect to the engagement point P1, but the disclosure is not necessarily limited thereto. For example, the initial point P2 of the rotation shafts 60, 260, and 360 may be positioned on the front side with respect to the engagement point P1. That is to say, it is possible to apply the support method for the hammers 6, 206, 306, and 406 of the above embodiments (the structure for supporting the rotation shafts 60, 260, 360, and 460 on the support surfaces 43a, 243a, 343a, and 443a that incline with respect to the horizontal direction) even in other known keyboard devices in which the pressing portions 62 of the hammers 6, 206, 306, and 406 are positioned on the back side of the rotation shafts 60, 260, 360, and 460. The keyboard device described in International Publication No. 2021/124479 is exemplified as an example of such other known keyboard devices.

Each of the above embodiments illustrates a case where the support surfaces 43a, 243a, 343a, and 443a are flat surfaces having a descending inclination as they approach the engagement point P1, but the disclosure is not necessarily limited thereto. For example, the support surfaces 43a, 243a, 343a, and 443a may have a descending inclination as they extend away from the engagement point P1, or a part or all of the region of the support surfaces 43a, 243a, 343a, and 443a may be formed with a curved surface.

Each of the above embodiments illustrates a case where the upper surface side of the support surfaces 43a, 243a, 343a, and 443a is open, but the disclosure is not necessarily limited thereto. For example, a wall (a wall facing in parallel with the support surfaces 43a, 243a, 343a, and 443a) may be provided to restrict movement of the rotation shafts 60, 260, 360, and 460 in the direction away from the support surfaces 43a, 243a, 343a, and 443a. As an example of such a configuration, for instance, a wall is formed to cover the outer peripheral surface 460b of the rotation shaft 460 of the fourth embodiment from above (a wall that sandwiches the rotation shaft 460 with the support surfaces 443a).

As an example of the structure that pivotally supports the engagement portion between the key 2 and the hammers 6, 206, 306, and 406 in a non-slidable manner, each of the above embodiments illustrates a structure in which the protrusion portion 20 having an arc-shaped tip is inserted into the receiving portion 63 having an arc-shaped bottom surface, but the disclosure is not necessarily limited thereto. Regarding the structure that pivotally supports the key 2 and the hammers 6, 206, 306, and 406 in a non-slidable manner, other known technologies can also be adopted, and the structures described in International Publication No. 2021/124477 and Japanese Patent Application Laid-Open No. 2024-093678 are exemplified as such technologies.

Each of the above embodiments illustrates a case where key pressing information of the key 2 is detected by the switch 70 being pushed by the hammers 6, 206, 306, and 406, but the disclosure is not necessarily limited thereto. For example, the switch 70 may be configured to be pushed by the key 2, or key pressing information of the key 2 may be detected by a non-contact type sensor.

Each of the above embodiments illustrates a case where the key 2 and the hammers 6, 206, 306, and 406 are supported by the common chassis 4, 204, 304, and 404, but the member that supports the key 2 and the member that supports the hammers 6, 206, 306, and 406 (on which the support surfaces 43a, 243a, 343a, and 443a are formed) may be separate members.

In the first embodiment described above, the description of the relationship between the displacement amount (ascent amount) in the case of the hammer 6 (rotation shaft 60) ascending on the support surface 43a from the initial position before key pressing to the intermediate position, and the displacement amount (descent amount) in the case of the hammer 6 descending on the support surface 43a from the intermediate position of key pressing to the terminal position, is omitted. These ascent amount and descent amount may be the same or may be different. That is, for example, the descent amount of the hammer 6 may be larger than the ascent amount, or the descent amount may be smaller than the ascent amount.

The first embodiment described above illustrates a case where the hammer 6 (rotation shaft 60) ascends and then descends on the support surface 43a from the initial position before key pressing to the terminal position, but the hammer 6 (rotation shaft 60) may descend and then ascend on the support surface 43a from the initial position before key pressing to the terminal position.

What is claimed is:

1. A keyboard device, comprising:
a key which has a back end side swingably supported;
a hammer with which the key is rotatably engaged and which rotates in conjunction with swinging of the key; and
a support member which has a support surface that slidably supports an outer peripheral surface of a rotation shaft of the hammer,
wherein the support surface inclines with respect to a horizontal direction, and
the rotation shaft of the hammer ascends or descends on the support surface during swinging of the key.

2. The keyboard device according to claim 1, wherein
the support surface has a descending inclination as the support surface approaches an engagement portion between the key and the hammer.

3. The keyboard device according to claim 2, wherein
the rotation shaft reciprocates on the support surface in a case where the key swings from an initial position before key pressing to a terminal position of key pressing.

4. The keyboard device according to claim 3, wherein
the rotation shaft ascends and then descends on the support surface in a case where the key swings from the initial position before key pressing to the terminal position of key pressing.

5. The keyboard device according to claim 1, further comprising:
a sensor which is pushed by the key or the hammer during pressing of the key,
wherein a load acting on the key from the hammer gradually decreases from an initial position before key pressing to a position where the sensor is pushed.

6. The keyboard device according to claim 1, wherein
the hammer comprises a pair of guided surfaces which are formed on side surfaces on both sides in a scale direction,
the support member comprises a pair of guide surfaces which sandwich the pair of guided surfaces, and
sliding of the rotation shaft on the support surface is guided by contact between the guided surfaces and the guide surfaces.

7. The keyboard device according to claim 1, wherein
the outer peripheral surface of the single rotation shaft formed on the hammer is supported by the support surface.

8. The keyboard device according to claim 1, wherein
the support surface has the back end side and a front end side,
the support surface is a flat surface that inclines at a constant gradient from the back end side to the front end side.

9. The keyboard device according to claim 1, wherein
the support member further includes a horizontal surface that connects to a front end of the support surface, and
the horizontal surface extends in a front-back direction of the support member.

10. A hammer support method for a keyboard device that comprises a key which has a back end side swingably supported, a hammer with which the key is rotatably engaged and which rotates in conjunction with swinging of the key, and a support member which has a support surface that supports a rotation shaft of the hammer, the hammer support method comprising:
slidably supporting an outer peripheral surface of the rotation shaft of the hammer on the support surface that inclines with respect to a horizontal direction; and
causing the rotation shaft of the hammer to ascend or descend on the support surface during swinging of the key.

11. The hammer support method according to claim 10, wherein
the support surface has a descending inclination as the support surface approaches an engagement portion between the key and the hammer.

12. The hammer support method according to claim 11, wherein
the rotation shaft reciprocates on the support surface in a case where the key swings from an initial position before key pressing to a terminal position of key pressing.

13. The hammer support method according to claim 12, wherein
the rotation shaft ascends and then descends on the support surface in a case where the key swings from the initial position before key pressing to the terminal position of key pressing.

14. The hammer support method according to claim 10, further comprising:
providing a sensor which is pushed by the key or the hammer during pressing of the key,
wherein a load acting on the key from the hammer gradually decreases from an initial position before key pressing to a position where the sensor is pushed.

15. The hammer support method according to claim 10, wherein
the hammer comprises a pair of guided surfaces which are formed on side surfaces on both sides in a scale direction,
the support member comprises a pair of guide surfaces which sandwich the pair of guided surfaces, and
sliding of the rotation shaft on the support surface is guided by contact between the guided surfaces and the guide surfaces.

16. The hammer support method according to claim 10, wherein
the outer peripheral surface of the single rotation shaft formed on the hammer is supported by the support surface.

17. The hammer support method according to claim 10, wherein
the support surface has the back end side and a front end side,
the support surface is a flat surface that inclines at a constant gradient from the back end side to the front end side.

18. The hammer support method according to claim 10, wherein
the support member further includes a horizontal surface that connects to a front end of the support surface, and
the horizontal surface extends in a front-back direction of the support member.

19. An electronic piano, comprising:
a keyboard device, comprising:
a key which has a back end side swingably supported;
a hammer with which the key is rotatably engaged and which rotates in conjunction with swinging of the key; and
a support member which has a support surface that slidably supports an outer peripheral surface of a rotation shaft of the hammer,
wherein the support surface inclines with respect to a horizontal direction, and
the rotation shaft of the hammer ascends or descends on the support surface during swinging of the key.

20. The electronic piano according to claim 19, wherein
the support surface has a descending inclination as the support surface approaches an engagement portion between the key and the hammer.
